(19) United States
(12) Patent Application Publication
(10) Pub. No.: US 2017/0333995 A1
(43) Pub. Date: Nov. 23, 2017

(54) METHOD FOR CONNECTING WORKPIECES WHICH ARE PRODUCED FROM A RAW MATERIAL USING AN ADDITIVE MANUFACTURING PROCESS`

(71) Applicant: Siemens Aktiengesellschaft, Munich (DE)

(72) Inventors: Michael Ott, Mülheim an der Ruhr (DE); Steffen Walter, Oberpframmern (DE)

(73) Assignee: Siemens Aktiengesellschaft, Munich (DE)

(21) Appl. No.: 15/535,183

(22) PCT Filed: Dec. 2, 2015
(86) PCT No.: PCT/EP2015/078295

§ 371 Date: Jun. 12, 2017

(30) Foreign Application Priority Data
Dec. 18, 2014 (DE) 10 2014 226 370.0

(51) Int. Cl. B22F 7/06; B33Y 80/00; B22F 3/105; F01D 5/14; B33Y 10/00; B33Y 50/00; B23K 26/342; B23K 101/00

(52) U.S. Cl. CPC B22F 7/062; B33Y 50/00; B33Y 80/00; B23K 26/342; B22F 3/105; B22F 3/1055; F01D 5/147; B33Y 10/00; B22F 2003/1057; B23K 2201/001; F05D 2220/32; F05D 2230/22; F05D 2230/31; B22F 2003/1051

(57) ABSTRACT

A method for the additive manufacturing of a workpiece from a raw material, having at least one metal, wherein a geometric model of the workpiece is produced and the model is divided into a plurality of individual parts. Each individual part is manufactured in stages from the raw material. In a manufacturing step, a respective amount of the raw material is locally fused to an already manufactured part of the respective individual part using localized application of heat, and solidified in the same place, and wherein the individual parts are joined by a diffusion process using the application of pressure and the local application of heat at the contact surfaces, and in this way the finished workpiece is joined. A workpiece is manufactured from a raw material by a method of this type.

### CROSS REFERENCE TO RELATED APPLICATIONS

This application is the US National Stage of International Application No. PCT/EP2015/078295 filed Dec. 2, 2015, and claims the benefit thereof. The International Application claims the benefit of German Application No. DE 102014226370.0 filed Dec. 18, 2014. All of the applications are incorporated by reference herein in their entirety.

### FIELD OF INVENTION

The invention relates to a method for the additive manufacture of a workpiece from a raw material which comprises at least one metal, wherein a mathematical model of the workpiece is generated, and in each production step, a unit of quantity of the raw material is locally melted, with localized introduction of heat, and solidified onto an already-finished part.

### BACKGROUND OF INVENTION

Additive manufacturing methods represent a novel approach to the production of workpieces having very high geometric complexity, and have made great strides in recent years. An essential feature of additive manufacturing methods is that a low-dimensional raw material (for example a wire or a foil) or an amorphous raw material (for example a powder or a liquid) is shaped step by step, by means of chemical and/or physical processes, on the basis of virtual data models of a workpiece to give the finished workpiece.

In particular in the field of internal combustion engines, additive manufacturing methods make it possible on one hand to create improved components which are difficult or impossible to produce using conventional methods, for example workpieces with tailored material properties, low weight or internal surfaces for optimized cooling. This thus permits an increase in efficiency and a reduction in the cost of new parts. Another aspect is that additive manufacturing methods offer great simplification in the context of service and repair by permitting individual, decentralized and instantaneous manufacturing.

Of particular interest in this context are laser-supported manufacturing methods which make it possible to process the typical construction materials in the hot region of an internal combustion engine. In that context, manufacture typically takes place by scanning a powder bed with a laser beam, wherein the metallic particles of the starting material of which the powder consists—generally a nickel-based alloy—are melted together bit by bit and layer by layer to form the finished component.

Although an additive manufacturing method can be used to realize workpieces with shapes that are very difficult to produce in conventional manufacturing, such as undercuts or cavities, it is also subject to limitations. In particular, during simultaneous manufacture of thick-walled and thin-walled structures in a workpiece, the internal stresses that arise in the workpiece during the production process can lead to warping. These internal stresses stem from the different thermodynamic requirements for the arrangement of the atoms in the respective local crystal structure which prevail in thick-walled and/or thin-walled structures: the local dissipation of the heat introduced to add the particles takes place almost entirely through the already-finished part of a workpiece. Thus, a thick-walled structure permits a larger thermal gradient, as a result of which the heat is removed more quickly than is the case in a thin-walled structure, where molten material remains in the liquid phase for longer. This can also lead to precipitation processes in the alloy that is used.

The stresses which, on solidification, are “frozen” in the various structures of a workpiece can then be greater than the yield point of the workpiece, which can result in cracks. In addition, warpage during production can damage the production installation.

### SUMMARY OF INVENTION

The invention is therefore based on an object of providing a method for manufacturing a workpiece from a raw material, which method makes it possible to create shapes that are as complex as possible and, in so doing, causes minimum warpage in the finished workpiece.

The stated object is achieved, according to the invention, with a method for the additive manufacture of a workpiece from a raw material which comprises at least one metal, wherein a geometric model of the workpiece is generated and the model is split into a plurality of individual parts, wherein each individual part is produced stepwise from the raw material whereby, in each production step, a unit of quantity of the raw material is locally melted, with localized heat input, and solidified onto an already-finished part of the respective individual part, and wherein the individual parts are joined together by a diffusion process under pressure and localized heat input at the contact surfaces, and thus the finished workpiece is joined.

Advantageous and sometimes individually inventive embodiments are set forth in the dependent claims.

In the present case, the raw material is a metal or an alloy. In that context, a unit of quantity of the raw material is in particular a grain of powder or granulate. In that context, the localized melting of the unit of quantity of the raw material by localized introduction of heat encompasses, in particular, complete melting as well as melting in which the melting process remains reduced at the surface of the respective unit of quantity, that is to say in particular also a sintering process. The contact surfaces at which the individual parts are in each case joined under the action of pressure and localized heat input are predetermined by the geometric model of the workpiece. In particular, the geometric model of the workpiece is used for individual production steps for adding a respective unit of quantity of the raw material.

In that context, a first step of the invention assumes that, with increasing geometric complexity of a workpiece that is to be manufactured, conventional production such as a forging or casting process with subsequent machining generally involves a disproportionate workload and thus unjustifiable costs. The problems which arise during additive manufacture of a workpiece with complex geometry, in particular with regard to material stresses, should therefore be solved as far as possible in the context of an additive manufacturing process.

In this context, it is recognized that, in particular in order to reduce material stresses in the melted and solidified raw material, which stem from differential incorporation of the atoms thus added into the crystal structure of the workpiece, it is possible to optimize the individual production steps and the respective localized introduction of heat in the spatial sequence. Proceeding from a spatial arrangement of local melt points—predefined by the geometry of the workpiece—such an optimization of the time distribution of respective local melting procedures does however imply, inter alia, a multiple coupled application and simulation of the heat conduction equation, which also results in a disproportionate increase in workload. This is even more true for workpieces with complex geometry, the production of which is of particular relevance here.

It is also possible, by subsequent processing of a workpiece by means of heat and pressure, to eliminate certain stresses and/or deformations in the finished workpiece if necessary, although to eliminate damage to a crystal structure caused by such stresses, for example cracks, it is generally necessary to use pressures which can compromise the structure of the finished workpiece. Subsequent processing of this type is therefore rejected.

By contrast, the invention proposes producing various individual parts of the workpiece in each case separately by means of the described production steps. In that context, the invention recognizes, in a second step, that this approach makes it possible to choose the dimensions of the individual parts such that problems in terms of the material structure of the workpiece, in particular stresses, which stem from the individual melting and solidification processes, do not arise to a noteworthy degree. In that context, the division of the workpiece into various individual parts is done by means of a geometric model which is generally present in any case for the spatial division of the individual production steps, in each case adding a unit of quantity of the raw material.

In particular during simultaneous manufacture of thick-walled and thin-walled structures in the workpiece, it is possible for differential warping to occur in the respective structures, such that here splitting the workpiece into individual parts that are subsequently joined makes it possible to achieve a markedly improved manufacturing quality, since warping is easier to suppress in smaller individual parts.

In this context, it proves more advantageous if the final joining takes place under a pressure that causes only slight elastic deformation of the workpiece that is to be joined, wherein in each case the local evolution of heat is taken into account for the diffusion processes for joining the individual parts.

Advantageously, a plurality of individual parts are joined together under unidirectional pressure. In particular, all of the individual parts are joined together under unidirectional pressure. In particular, this can also take place stepwise, such that first various groups of individual parts are respectively joined together under unidirectional pressure to give coarse structures, and then the coarse structures are in turn assembled under unidirectional pressure which does not act along the joining axis of the coarse structures, to give the finished workpiece. Unidirectional pressure is particularly simple to generate in the production process.

Expediently, the local action of heat at the adjoining contact surfaces of any two individual parts is achieved by means of an externally applied current via the ohmic resistance arising at the adjoining contact surfaces. Depending on the raw material used, the individual parts respectively have high internal electrical conductivity. If a current is now applied to two individual parts each having a contact surface, the ohmic resistance at the contact surface is markedly higher than inside the respective individual parts. Thus, the applied current leads to a marked local heating action at the touching contact surfaces. While the current is applied, this evolution of heat is maintained until the two individual parts have formed a material bond at their contact surfaces by virtue of sufficient diffusion of the atoms, and thus by virtue of the improved mobility of the charge carriers there the ohmic resistance drops again. By virtue of the limitation, so achieved, of the local heating action at the contact surfaces provided on the individual parts, the final joining of the individual parts to give the finished workpiece is particularly energy-efficient. In addition, it is possible to dispense with excessive external heating action, which could compromise the external shape and/or structure of the individual parts.

Expediently, in this context, a plurality of individual parts is joined by spark plasma sintering. Spark plasma sintering is an established industrial process, the application of which in the present method for joining the individual parts creates a particularly homogeneous structure in the finished workpiece.

It is moreover advantageous if a plurality of individual parts is created in each case layer by layer from the raw material. In particular in manufacturing methods in which a workpiece is manufactured additively layer by layer from a metallic raw material, it is possible for stresses to arise in the material during the manufacturing process in the layering direction in the already-finished part of the workpiece. These stresses can lead to deformation or warping of the already-finished part of the workpiece, which can even, inter alia, endanger the installation for the manufacturing process. Against this backdrop, the stated production method is particularly advantageous in the context of layered buildup of the individual parts. In particular, it is in this context also possible for an individual part to comprise additional auxiliary structures which, with regard to the geometry of the individual part in question, are designed to facilitate or even permit the layered buildup of the individual part from the raw material. Advantageously, these auxiliary structures are to be removed prior to joining of the individual parts to give the finished workpiece.

Advantageously, in this context, a plurality of individual parts is manufactured in parallel in an installation for layered production. Parallel manufacture of this type is to be understood as meaning that a layer is added to an already-finished part of an individual part, and before another layer is added there, at least one layer is added to an already-finished part of another individual part.

This approach has the following advantages: First, it is often necessary for the installation to undergo a preparation process after a single manufacturing step or after a plurality of manufacturing steps. This preparation process can for example consist in correctly arranging the raw material on the already-finished part of an individual part. If the raw material is in powder form, the preparation process involves providing a plane of powder which completely covers the already-finished part of a workpiece and which must have as smooth a surface as possible, to which end the powder is also separately smoothed. By manufacturing multiple individual parts of the same workpiece in parallel in the same installation, the time for a preparation process of a manufacturing step or of a layer for multiple individual parts is thus used at the same time, as a result of which it is possible to substantially reduce the overall manufacturing time.

Second, manufacturing multiple individual parts simultaneously, in parallel and in the same installation permits improved removal of the quantity of heat introduced locally for creating a layer. In the case of one-piece layered manufacture of the workpiece, each individual layer is added in a multiplicity of manufacturing steps with in each case local introduction of heat for melting the relevant unit of quantity of raw material. When considered in spatial terms, in this context the sum of all the local heat inputs, which are necessary for adding a layer, forms a maximum single coverage of the already-finished part of the workpiece. Now, if a workpiece is manufactured layer by layer and in one piece, then at a certain point on the surface of the already-finished part, the next local introduction of heat takes place markedly earlier than would be the case if corresponding parallel layers of other individual parts had to be created first. Thus, during layered manufacturing, the individual parts maintain better heat dissipation than would a workpiece created in one piece, which can have an advantageous effect on the solidification process, depending on the raw material. Among other things, in the context of more rapid solidification it is possible to better prevent undesired precipitation of individual material phases of the raw material.

Particularly, the raw material is provided in powder form. In this case, the local introduction of heat is concentrated essentially in a point, such that the improved heat dissipation can have a particularly advantageous effect.

Expediently, to that end the raw material is melted locally by selective laser melting. Selective laser melting is a particularly widespread process for providing the local heat input for an additive manufacturing method with a powdery raw material.

The invention also specifies a workpiece which is made from a raw material using the above-described method. The advantages set out for the method and the refinements thereof can, as appropriate, be applied to the workpiece. In particular, the workpiece is configured as a component of an internal combustion engine.

### BRIEF DESCRIPTION OF THE DRAWINGS

There follows a more detailed explanation of an exemplary embodiment of the invention, with reference to a drawing, in which, schematically:

FIG. 1 shows, in a diagram, the sequence of a method for additive manufacturing of a workpiece from a raw material,

FIG. 2 shows, in an oblique view, the parallel production of multiple individual parts in the same installation, and

FIG. 3 shows, in an oblique view, the joining of individual parts to give a finished workpiece as shown in FIG. 1.

Mutually corresponding parts and variables are in each case provided with identical reference signs in all figures.

### DETAILED DESCRIPTION OF INVENTION

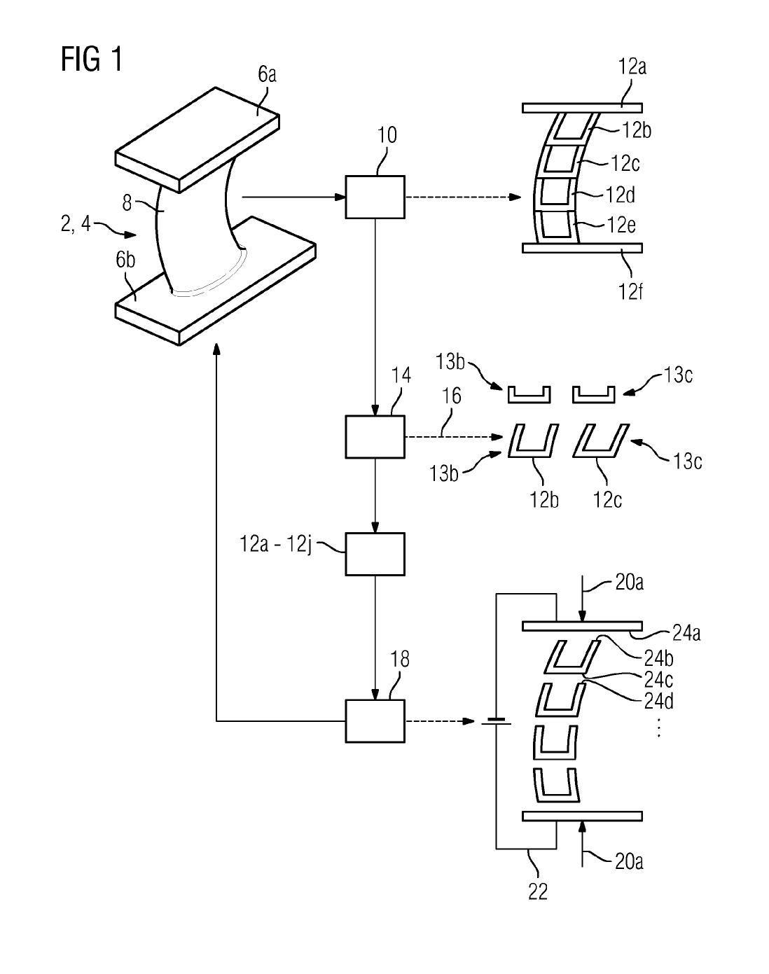

FIG. 1 shows, in a schematic diagram, the sequence of a method 1 for producing a workpiece 2. In that context, the workpiece 2 is designed as a turbine blade 4 of a gas turbine (not shown in greater detail). The turbine blade 4 has two platforms 6a, 6b and a profiled airfoil 8. Now, a first method step involves establishing a geometric model 10 of the workpiece 2. Now, this geometric model 10 is first divided into individual parts 12a -12f, wherein the conditions in the installation provided for manufacturing the individual parts 12a -12f are also to be taken into account for advantageous division.

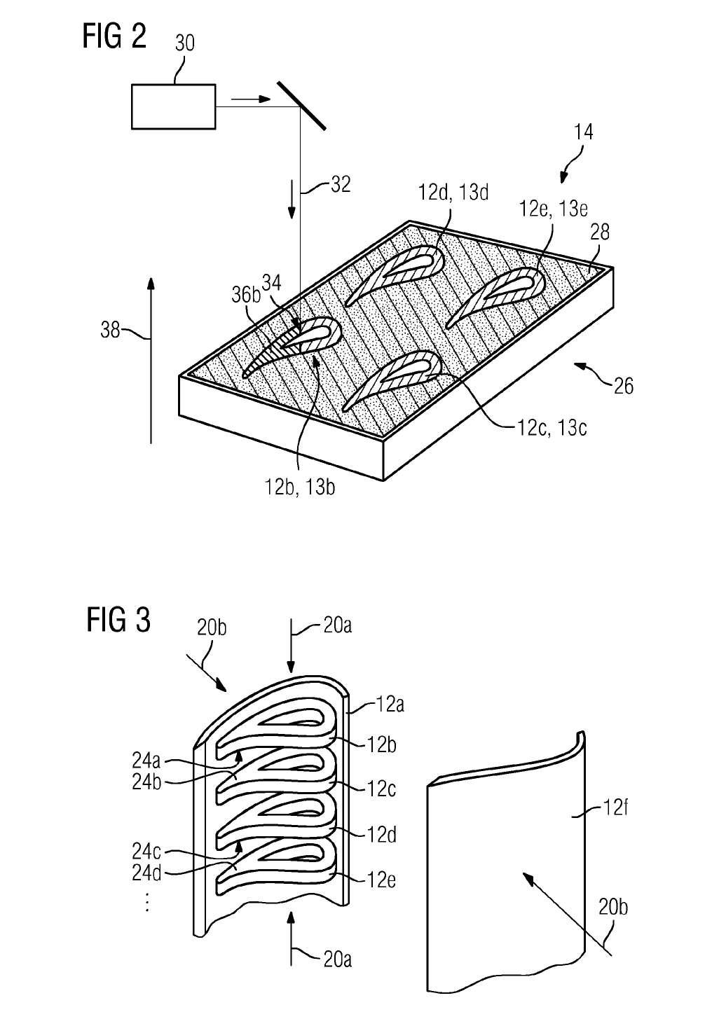

In the next method step, the individual parts 12a -12f are then manufactured layer by layer from a raw material 14 in an installation (not shown in greater detail). To that end, the raw material 14, which in this case is in the form of a powdered metal alloy, is locally melted by selective laser melting 16 in a multiplicity of individual manufacturing steps, such that a quantity of powder melted in one manufacturing step by the local heat input of the laser solidifies on an already-finished part 13b, 13c of an individual part 12b, 12c, and thus the next layer is formed step by step. The geometric model 10 of the workpiece 2 can be used in this case for the layered buildup of the individual parts 12a -12f. Depending on their geometry, certain groups of individual parts 12b, 12c are manufactured in parallel here. Details of this manufacture are explained in greater detail with reference to FIG. 2.

The individual parts 12a -12f are finally joined by spark plasma sintering 18. To that end, a unidirectional pressure 20a is first exerted on the individual parts 12a -12f in the direction of the layered buildup, and a current 22 is applied through the individual parts 12a -12f. The spark plasma sintering 18 produces, at the contact surfaces 24a -24d of the individual parts 12a -12f provided by the geometric model 10, sufficient diffusion of the alloy such that any two adjacent individual parts 12a -12f are thereby solidly connected to one another, and can thus be joined to give the finished workpiece 2. Details of this joining process are explained in greater detail with reference to FIG. 3.

FIG. 2 shows, schematically in an oblique view, an installation 26 for selective laser melting. The already-finished parts 13b-13e of the individual parts 12b -12e, which have a similar geometry in each case, are in a powder bed 28. A laser 30 scans the powder bed28 according to the geometry of the individual parts 12b -12e, with each individual laser pulse corresponding to a manufacturing step 32 in which a unit of quantity 34 of powder grains is melted. The raw material 14 melted in this manner solidifies on the already-finished part 13b of the individual part 12b, and so a next layer 36b is deposited on the already-finished part 13b of the individual part 12b by a multiplicity of such manufacturing steps 32. Before another layer of raw material 14 is deposited onto this layer 36b, a layer is first deposited onto the already-finished part 13c-13e of every other individual part 12c -12e, such that the individual parts 12b -12e are formed by layers that are parallel in the buildup direction 38, and at any stage of the manufacture in the installation 26 any two individual parts 12b -12e arising simultaneously there differ in the buildup direction 38 by at most one layer 36b.

Manufacturing the individual parts 12b -12e in parallel in this manner makes it possible to save manufacturing time which is necessary at every new layer for preparation and smoothing of the powder bed 28, since the parallel manufacturing now means that, overall, fewer layers and thus fewer individual preparation processes of this type are required. In addition, in the buildup direction 38 heat dissipation from an already-finished part 13b-13e is better than in the case of one-piece manufacturing of a workpiece, since the time for the laser 30 to return to irradiate the same location after one manufacturing step 32 for a layer 36b when manufacturing the next-higher layer is greater due to the other individual parts that are still to be processed beforehand.

FIG. 3 shows, schematically in an oblique view, the joining of individual parts 12a -12f to give a finished turbine blade 4. In a first step, individual parts 12b -12e, which in the geometric model of the turbine blade 4 represent a disk-like division of an internal structure of the airfoil 8, and the platforms 6a, 6b, which are not shown in greater detail here, are joined together by a first spark plasma sintering process in which the pressure 20a acts perpendicular to the contact surfaces 24a -24d provided on the individual parts. In a second step, a second spark plasma sintering process adds external airfoil surfaces 12a, 12f to the internal structure formed by the individual parts 12b -12e, wherein the pressure 20b used for this, or the arrangement of the individual parts defined by the geometric model 10, acts perpendicular to the pressure 20a used in the first spark plasma sintering process.

Although the invention has been described and illustrated in greater detail by means of the preferred exemplary embodiment, the invention is not limited by this exemplary embodiment. Other variants can be derived herefrom by a person skilled in the art without departing from the protective scope of the invention.

1.-9. (canceled).

10. A method for the additive manufacture of a workpiece from a raw material which comprises at least one metal, the method comprising:
generating a geometric model of the workpiece and splitting the model into a plurality of individual parts,
wherein each individual part is produced stepwise from the raw material wherein, in each production step, a unit of quantity of the raw material is locally melted, with localized introduction of heat, and solidified onto an already finished part of the respective individual part, and
joining the plurality of individual parts together by a diffusion process under unidirectional pressure and localized heat input at the contact surfaces, whereby the finished workpiece is joined.

11. The method as claimed in claim 10,
wherein the local introduction of heat at the adjoining contact surfaces of any two individual parts is achieved by an externally applied current via the ohmic resistance arising at the contact surfaces.

12. The method as claimed in claim 10,
wherein at least one of the plurality of individual parts is joined by spark plasma sintering.

13. The method as claimed in claim 10,
wherein the plurality of individual parts is created in each case layer by layer from the raw material.

14. The method as claimed in claim 13,
wherein the plurality of individual parts is manufactured in parallel in an installation for layered production.

15. The method as claimed in claim 13,
wherein the raw material is provided in powder form.

16. The method as claimed in claim 15,
wherein the raw material is melted locally by selective laser melting.

17. A workpiece,
wherein the workpiece is created from a raw material using a method as claimed in claim 10,
whereby in the workpiece, problems in the material structure of the workpiece, which stem from individual melting and solidification processes, and/or stresses, are not present to a noteworthy degree.
